(19) United States
(12) Patent Application Publication
(10) Pub. No.: US 2010/0147168 A1
(43) Pub. Date: Jun. 17, 2010

(54) STAMPING FOIL UNIT

(75) Inventors: Uwe Puschel, Heidesheim (DE); Jurgen Scholzig, Mainz (DE); Detlef Krause, Oestrich-Winkel (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: manroland AG, Offenbach (DE)

(21) Appl. No.: 12/295,844

(22) PCT Filed: Mar. 17, 2007
(86) PCT No.: PCT/EP07/02378

§ 371 Date: Dec. 8, 2008

(30) Foreign Application Priority Data
Apr. 3, 2006 (DE) 10 2006 015 829.6
Mar. 2, 2007 (DE) 10 2007 010 204.8

(51) Int. Cl. B41F 7/02

(52) U.S. Cl. 101/217

(57) ABSTRACT

To transfer a coating in image form from a transfer foil to a print sheet, adhesive is applied in the form of the image to said sheet. In a foil transfer module (2), the carrier foil with the coating in image form is then brought into contact with the print sheet using contact pressure, so that the coating adheres to the adhesive pints and an image is produced. To improve the function, simplify the device and increase the flexibility of the method, a transfer cylinder (3) is provided with a covering that has a variable cover thickness (25), in order to adapt the surface speed of the transfer cylinder (3).

### CROSS-REFERENCE TO RELATED APPLICATIONS

This patent application is the national phase of PCT/EP2007/002378, filed Mar. 17, 2007, which claims the benefit of German Patent Application Nos. 102006015829.6 and 102007010204.8, filed Apr. 3, 2006 and Mar. 2, 2007, respectively.

### FIELD OF THE INVENTION

The invention relates to a device for transferring image-forming layers from a carrier foil onto printed sheets.

### BACKGROUND OF THE INVENTION

Producing metal layers on printed sheets by a foil transfer process is known. A printing material and a printing device are described in EP 0 569 520 B 1. In this reference, a sheet-processing machine is disclosed that has a feeder mechanism and a delivery mechanism. Printing couples and a foil transfer module are arranged between the feeder and delivery mechanisms. An adhesive pattern is applied in at least one of the printing couples by a planographic printing method. This adhesive pattern is applied in a cold printing process and has a predetermined image-forming motif.

A foil guide is provided in the foil transfer module with an impression cylinder and a transfer cylinder that is situated downstream of the printing couple. The foil guide is designed in such that a foil strip or a transfer foil is guided through the transfer nip of the foil transfer module, between the impression cylinder and the transfer cylinder. The foil strip is wound back up on the outlet side after leaving the foil transfer module. The transfer foil has a carrier layer on which image-forming layers such as metal layers, aluminum in particular, can be placed.

In the transport of the printing sheet through the printing couple, each printing sheet is furnished with an adhesive pattern. Thereafter, the printing sheet is guided through the foil transfer module, wherein the printing sheet lying on the impression cylinder is brought into contact with the foil material by the transfer cylinder. During this process, the metal layer facing downwards undergoes a tight connection to the areas covered with adhesive on the printing sheet. After further transport of the printing sheet, the metallic layer adheres only in the area of the pattern furnished with adhesive. That is to say, the metallic layer is removed from the transfer foil in the area of the adhesive pattern. The consumed transfer foil is wound back up. The printing sheet is delivered in the coated state. The use of such foil transfer modules in the printing couples of printing machines is known. A disadvantage of the known devices is that they cannot be used flexibly, and that the consumption of transfer foil is expensive.

### OBJECTS AND SUMMARY OF THE INVENTION

Accordingly, an object of the invention is to provide an easy to operate and handle device for economically and precisely transferring an image-forming layer, for instance, a metallic layer.

Advantageously, the present invention can utilize a transfer method in which the transfer foil is processed during the foil transfer by a transfer cylinder with a high contact pressure. In an additional configuration, an elevated pressing surface, having a contoured outline, that is limited to the area to be coated can be provided. The elevated pressing surface can comprise a cutout printing blanket, a plastic from or an adherable pressing segment. Advantageously, the advancement of the transfer foil can thereby be stopped even if the area to be coated lies inside the image area.

Other objects and advantages of the invention will become apparent upon reading the following detailed description and upon reference to the drawings, in which:

### BRIEF DESCRIPTION OF THE DRAWINGS

FIG. 1 is a schematic side view of an exemplary printing machine with a foil transfer module according to the invention.

FIG. 2 is a schematic side view of a transfer cylinder in the foil transfer module of FIG. 1.

FIG. 3 is a schematic partial side view of the transfer cylinder of FIG. 2 showing the structure of a pressing cover.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

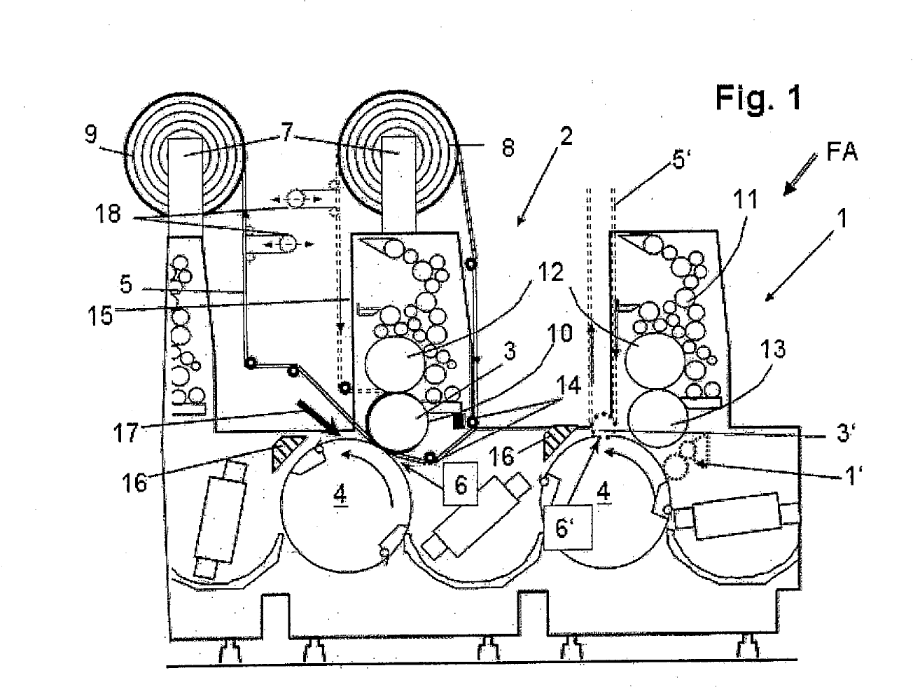

A sheet-processing machine, a printing machine in this case, that consists of at least two printing couples is shown in FIG. 1. In a first step, a printing sheet to be coated is furnished in an application unit 1 with an image-forming adhesive pattern. For this purpose, a printing couple of an offset printing machine with inking and dampening units 11, a printing plate on a plate cylinder 12, a printing blanket or rubber cylinder 13 and an impression cylinder 4 is used. Application units in the form of flexographic printing or varnishing units can likewise be used.

In a second step, a transfer foil 5 is guided together with the printing sheet through a transfer nip 6. A foil transfer module 2 used for this purpose can be a printing couple, a varnishing module, a base unit or some other type of processing station of a sheet-fed offset machine. The transfer gap 6 in the foil transfer module 2 is formed by a transfer cylinder 3 and an impression cylinder 4. The transfer cylinder 3 can comprise a blanket or forming cylinder of a conventional offset printing couple or varnishing module of a sheet-fed offset printing machine. A web guide for transfer foils 5 is shown in FIG. 1 inside the foil transfer module 2.

The foil transfer module 2 has an associated foil supply reel 8 on the side of the sheet feeder. The foil supply reel 8 includes a rotary drive 7. The rotary drive 7 provides a continuous regulated supply of transfer foil 5 to the foil transfer module 2 and is accordingly controllable. Guiding mechanisms 14, such as deflection and tensioning rollers, pneumatically operated guiding elements, guide sheets or the like are also provided in the foil supply and discharge area. The guiding mechanisms help ensure that the foil web of the transfer foil 5 runs without distortions and with the same tension relative to the transfer cylinder 3.

The transfer foil 5 can be run around the transfer cylinder 3, wherein the transfer foil 5 can advantageously be fed into and discharged from the pressing nip 6 from only one side of the foil transfer module 2 (see the dashed-line representation). In another embodiment, the transfer foil 5 can also be fed into and discharged from the pressing nip 6 substantially tangentially past the transfer cylinder 3, or wrapping around it by only a small circumferential angle. For this purpose, the transfer foil 5 is fed in from one side of the foil transfer module 2 and discharged at the opposite side of the foil transfer module 2. A foil take-up reel 9 for winding up used foil material is shown on the outlet side of the printing couple. In the illustrated embodiment, a controllable rotary drive 7 is also provided for the take-up reel.

In addition, a dryer 16 can be provided in the area where the adhesive and the foil are applied in order to improve the coating process. In particular, with UV drying, the adhesive layer can be pre-dried by a first dryer 16 (intermediate dryer I) so that the layer of transfer foil 5 adheres better. The adhesive effect of the stamped layer on the printing sheet can be further improved by a second dryer 16 (intermediate dryer II) that accelerates the drying of the adhesive.

For transferring the image-forming useful layer from transfer foil 5 onto the printing sheet in the nip 6 between the transfer cylinder 3 and the impression cylinder 4, the surface of transfer cylinder 3, i.e., the blanket cylinder or forming cylinder, should be equipped with a compressible damping element. To this end, the transfer cylinder 3 is equipped with a pressing cover 10 or has a corresponding pressing coating. The pressing cover 10 or coating can be constructed as a plastic coating, comparable to a rubber blanket or a printing blanket. The surface of pressing cover 10 is preferably very hard and smooth. It can be formed of anti-adhesive materials or structures. The pressing cover 10 can be held on the transfer cylinder 3 using clamping devices in a cylinder channel 19.

The foil transfer module can include a corresponding advancement control system for advancing the transfer foil 5 to ensure that at least the foil section lying between the transfer cylinder 3 and the impression cylinder 4 stops while a cylinder channel 19 is running past.

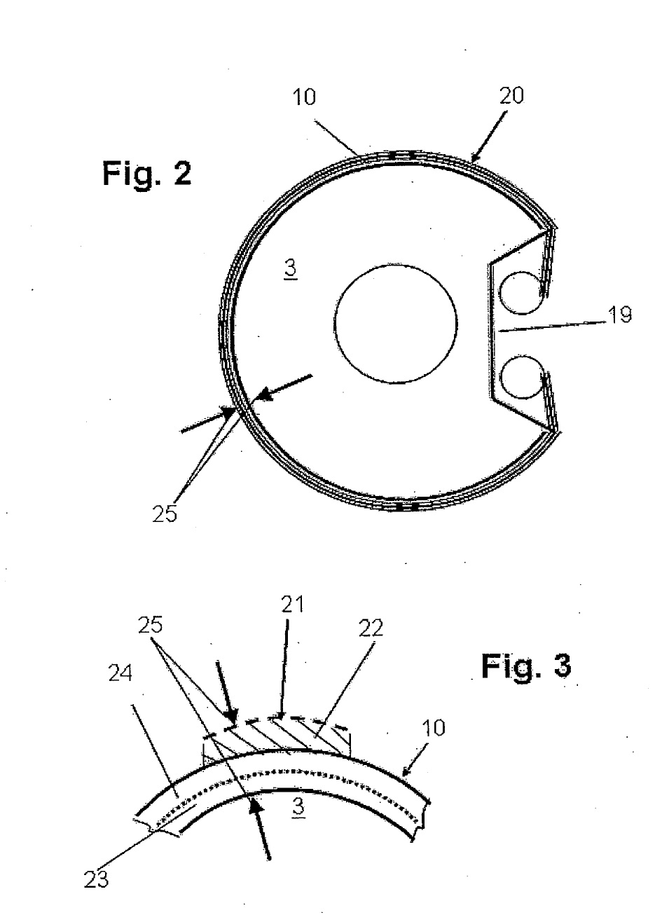

FIGS. 2 and 3 provide cross-sectional views through the transfer cylinder 3 or pressing cover 10 or through the coating on the surface of the transfer cylinder 3. To improve the transfer properties in the transfer nip 6, the pressing cover 10 can be configured with a deliberate elasticity such as by using a compressible intermediate layer. Preferably, the compressibility of the intermediate layer is similar to or less than the compressibility of conventional rubber or printing blankets, which could be used in the place of the intermediate layer. Additionally, combination pressing covers made of a hard printing blanket and a soft underlayer could be used.

The transfer cylinder 3 or pressing cover 10 can include a full-surface pressing surface 20 or a limited, segmented pressing surface 21. For this purpose, it is possible to use a cut-out printing blanket, a plastic intaglio printing form on which images can be formed, or a press-on segment 22 that can be mounted, glued (preferably detachably) or magnetically attached to a smooth base that supports the segmented pressing surface 21. For example, a press-on segment furnished with a magnetic adhesion surface on its underside can be placed directly on the surface of transfer cylinder 3. On the other hand, a magnetic foil, on which a press-on segment 22 equipped with a magnetically adhering back side for the placement or positioning of the segmented pressing surface 21 can be placed, can also be stretched onto the surface of transfer cylinder 3. The surface and the internal structure of press-on segment 22 should meet the specifications above with regard to elasticity and smoothness.

As compared to the compressibility provided by an intermediate compressible layer, a different type of compressibility can be produced by using a conventional printing blanket. Additionally, combination pressing covers made of a hard printing blanket and a soft underlayer could be used. A pressing cover 10 made of a printing blanket having a relatively thin, hard surface consisting of a plastic coating as a functional layer 24 is preferred. This functional layer 24 is furnished with a compressible substructure consisting of a compact elastic material or of closed-cell or open-cell foam. A force transferring layer, for instance, a fabric layer, should only be arranged thereunder. Thus, a still very high strength of the printing blanket or pressing cover 10 is achieved with a high flexibility of the surface. This has the special advantage that the transfer foil 5 adapts well to the respective substrate surface or the applied adhesive.

The surface of pressing cover 10 can be defined by a plastic covering 14 that is as smooth as possible. The plastic covering 14 can a low surface roughness with a peak-to-valley height of 1 μm or less. The material of the pressing cover 10 has as low an adhesion as possible to the material of the carrier foil of transfer foil 5.

Although the surfaces of rubber blankets are inherently very smooth, they still have a polishing pattern that results from the machining of the blanket. Moreover, the surfaces of rubber blankets are equipped to be very ink-adherent. Therefore, the transfer foil may tend to adhere to conventional rubber blankets. This in turn can lead to damage in the image forming layer transferred from the transfer foil 5 to the printing sheet B.

A clean transfer of the image forming layer onto the printed sheet is enabled by the plastic surface of the pressing cover 10, which is configured with a very low adhesion relative to the transfer foil 5, since the transfer foil 5 is actually pressed against the printing sheet only by the pressing cover 10 and is guided on the printing sheet by adhering to the adhesive sites on the printed sheet. The synchronous running of the foil web should be matched to this, so that shifts in the adhesive site cannot occur.

A very flexible transfer nip 6 is produced by using an elastic structure of the pressing cover 10 as described. Using a double-sized diameter impression cylinder 4 relative to the transfer cylinder 3, will enlarge the transfer nip 6 in the direction of a relatively flat extent. A somewhat larger printing impression between the transfer cylinder 3 and the impression cylinder 4 than is necessary in a conventional printing process can be selected in this case in order to generate an optimal transfer pressure in the transfer nip 6. For example, printing impression values of 0.10 mm to 0.14 mm, in comparison with a standard value of 0.10 mm, can be used.

To improve the foil transfer, the described arrangement produces an adaptation of the circumferential velocity of the active surface of the transfer cylinder 3 to the nature of the pressing cover 10 and the foil properties of the transfer foil 5. In this case, a compensation of the impression depth of the pressing cover 10 in the transfer nip 6 can be achieved with regard to the speed ratios that are in effect during the later transfer in the transfer nip 6.

For the speed ratios that are considered, the following general conditions result:

1. The impression cylinder 4 specifies a base speed for the foil transfer process.

2. The printing sheet B lies smoothly on the surface and is fixed on thye impression cylinder 4 by grippers, so that the surface speed of the printing sheet B defines the actual transfer speed.

3. The transfer foil 5 is supplied and removed synchronously with the surface speed of the printing sheet B.

4. Together with the surface of the impression cylinder 4, the surface of the transfer cylinder 3 forms the transfer nip 6.

5. The active surface of the transfer cylinder 3 is determined with respect to its position by the type and thickness 25 of the packing of the pressing cover 10.

6. Since the impression cylinder 4 itself, as well as the printing sheet B and the transfer foil 5, move in effect as a continuum, the movement and position of the surface of the transfer cylinder 3 represent the only variables for the layer transfer in the transfer nip 6.

7. The surface of the transfer cylinder 3 must be matched in position to the reference surface area defined by the impression cylinder 4, the printing sheet B and the transfer foil 5 by changing the position of the transfer cylinder 3 relative to the impression cylinder 4, wherein a compression of the pressing cover 10 must be taken into account.

8. Depending on the thickness 25 of the pressing cover 10, its compression in the transfer nip 6, as well as the relative position of the impression cylinder 4 and the transfer cylinder 3, different speed ratios result between the active surface of the transfer cylinder 3 and the transfer foil 5 being run past it.

Initially, a variation of the surface or circumferential velocity at the transfer cylinder 3 can be achieved by a roll-off variation on the transfer cylinder 3. For this purpose, the pressing cover 10 can be thickened to a value of up to 2.8% above the nominal diameter of a normally covered transfer cylinder. This implies, for a nominal diameter of 300 mm, an increase of the packing thickness 25 of the pressing cover by 0.84 mm in comparison to the nominal diameter results.

With an unchanged contact pressure of the transfer cylinder 3 with respect to the impression cylinder 4, a corresponding minimal speed difference is produced when taking into account the diameter change on the transfer cylinder 3 due to the contact pressure with a corresponding flattening of their pressing cover in the transfer nip 6. This adjustment causes the transfer foil 5 to be held flat, guided securely in the transfer nip 6 and transported such that the image forming layer is transferred in a tear-free manner to the printing sheet.

It can be an advantage in this regard if the surface of the pressing cover 10 of the transfer cylinder 3 is very smooth and is finished without a polishing pattern of the type familiar from conventional rubber blankets. Additionally, a very low compressibility of the pressing cover can be advantageous in order to bring produce the comparatively small dimensional deviations in the transfer nip 6. The known compression of the pressing cover 10 can be safely controlled in the transfer nip 6.

Under these general conditions, the same effect during the foil transfer in the transfer nip 6 can also be achieved by using a speed variation device, which can be associated with transfer cylinder 3. For example, the transfer cylinder 3 can be furnished with a special drive. Transmissions, such as continuously variable transmissions, also can be used for this purpose. For instance, so-called harmonic drive transmissions could be used. Other continuously adjustable variable transmissions, such as chain-link transmissions, also could be used. An independently controllable direct drive can likewise be provided on the transfer cylinder 3. The adaptation of the circumferential velocity of the surface of the transfer cylinder 3 with respect to the actual transport speed in the transfer nip 6 should lie in the range of roughly 0% to +3.5%. An advantage of a speed variation device is that it enables a variable adjustment of the desired differential velocity results, without requiring a reconstruction of the pressing cover 10 on the transfer cylinder 3. Moreover, the differential velocity can be adapted during operation even under varying boundary conditions such as fluctuating process temperatures or changing operating speeds. For this purpose, regulating mechanisms can be provided on the transfer module 2.

In addition, an adaptation of the web tension conditions to the respective foil quality that is available should be possible. Thus, the most favorable web tension for transfer foils with 15 μm thickness lies in the range of 10-45 Nm with a variation of ±10%. It can also make sense, however, to set these values for the web tension of the transfer foil 5 as a function of the manufacturing process of the respective transfer foil 5 being used, and provide them in general only within the scope of the thus-determined values. A setting of the web tension above the value set during production can lead to strain and additional stress on the carrier foil 5 and the transfer coating, as well as to adhesion between the two layers. Under certain conditions, dimensional changes of the transfer foil 5 or tears in the transfer layer can occur. A setting of the web tension below the value set during production can additionally lead to an insufficient widening and tightening of the carrier foil 5. Thus, there can be a risk that the transfer foil 5 will not run flat into the transfer nip 6.

An exemplary configuration of the pressing cover 10 is discussed above. A uniformly unbroken surface, i.e., preferably a full-surface arrangement of the pressing cover, is essential. The surface should be very smooth and, if possible, exhibit no polishing pattern. The compressibility should be kept to a low level. The surface can be formed from polymers. The hardness of the pressing cover can lie in the range of 60-90 Shore.

With the above-mentioned materials and settings, the transfer cylinder 3 takes on a transport function for the transfer foil 5 such that it is no longer subject to the tensile stress of the web tensioning regulation system in the transfer nip 6. Instead, the transfer cylinder 3 conveys the transfer foil 5 into the transfer nip 3 by the minimal speed difference, so that the image-forming layer is transferred in the transfer nip 3 in a manner that is nearly free of tensile stresses and can therefore be applied to the printing substrate without any tears.

### LIST OF REFERENCE NUMBERS

1 Application unit
2 Foil transfer module
3 Transfer cylinder
4 Impression cylinder
5 Transfer foil/Foil web
6 Transfer nip
7 Roller drive
8 Foil supply reel
9 Foil take-up reel
10 Pressing cover
11 Inking/moistening unit
12 Plate cylinder
13 Printing blanket cylinder
14 Guide device
15 Protective device
16 UV dryer
17 Monitoring system
18 Dancer roll
19 Cylinder channel
20 Pressing surface
21 Segmented pressing surface
22 Pressing segment
23 Printing blanket underlayer
24 Functional position
25 Packing thickness

1-15. (canceled)

16. A device for transferring an image-forming layer from a carrier foil of a transfer foil onto a printing sheet, comprising:
an application unit for applying an adhesive to areas of the printing sheet; and
a foil transfer module for transferring the image-forming layer from the carrier foil onto the printing sheet, the foil transfer module including an impression cylinder and a transfer cylinder that form a transfer nip;
the device being configured to guide the carrier foil relative to the transfer cylinder such that the carrier foil is placed with a coated side onto a printing sheet guided on the impression cylinder and to further guide the carrier foil under pressure together with the printing sheet through the transfer nip such that the image-forming layer adheres to the printing sheet in the areas furnished with adhesive and is lifted off the carrier foil after the printing sheet exits transfer nip;
the transfer cylinder having a surface with a covering, the transfer cylinder and covering defining an active surface of the transfer cylinder, the transfer cylinder with the covering being driveable at a speed at the active surface of the transfer cylinder that is up to 3% above a surface velocity of the impression cylinder with the printed sheet and the transfer foil lying thereon.

17. The device according to claim 16, wherein the covering on the surface of the transfer cylinder has a variable packing thickness.

18. The device according to claim 17, wherein the covering on the surface of transfer cylinder comprises a pressing cover and at least one underlayer.

19. The device according to claim 17, wherein the covering on the surface of transfer cylinder has a variable packing thickness that provides an effective diameter of the transfer cylinder of up to 0.9 mm greater than its nominal diameter with a normal packing thickness.

20. The device according to claim 16, wherein the covering on the transfer cylinder has a low compressibility and has minimal adhesion to the carrier foil.

21. The device according to claim 16, wherein the covering has a functional layer comprising a low surface tension layer and the covering has a compressible substructure.

22. The device according to claim 16, wherein the covering is detachably clamped onto the transfer cylinder and covers the entire surface of the transfer cylinder.

23. The device according to claim 16, further including a remotely adjustable device for varying a center distance of the transfer cylinder from the impression cylinder.

24. The device according to claim 16, further including a drive for the transfer cylinder, the drive being configured such that the speed of the active surface of transfer cylinder relative to the surface velocity of the impression cylinder can be varied.

25. The device according to claim 24, further including a continuously variable transmission operatively coupled to the transfer cylinder.

26. The device according to claim 24, wherein the drive comprises a drive motor with a continuously adjustable drive speed.

27. The device according to claim 24, further including a regulating mechanism for variably adjusting the speed of the active surface of transfer cylinder relative to the surface velocity of the impression cylinder as a function of an operating speed of the device.

28. The device according to claim 24, further including a regulating mechanism for variably adjusting the speed of the active surface of transfer cylinder relative to the surface velocity of the impression cylinder as a function of a web tension on the transfer foil.

29. The device according to claim 24, further including a regulating mechanism for variably adjusting the speed of the active surface of transfer cylinder relative to the surface velocity of the impression cylinder as a function of a contact pressure between the transfer cylinder and the impression cylinder including the thickness of the covering on the transfer cylinder.

30. The device according to claim 24, further including a regulating mechanism for variably adjusting the speed of the active surface of transfer cylinder relative to the surface velocity of the impression cylinder as a function of a temperature difference occurring in the foil transfer module.
